(19) United States
(12) Patent Application Publication
(10) Pub. No.: US 2005/0270981 A1
(43) Pub. Date: Dec. 8, 2005

(54) Method and system for providing the status of user equipment in a wireless local network interworking with 3GPP systems

(75) Inventors: Kamel M. Shaheen, King of Prussia, PA (US); Jeffrey Thomas Russell, Blue Bell, PA (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/141,216

(22) Filed: May 31, 2005

Related U.S. Application Data
(60) Provisional application No. 60/576,753, filed on Jun. 2, 2004.

(51) Int. Cl. H04L 12/26

(52) U.S. Cl. 370/241; 370/401; 370/338

(57) ABSTRACT

The present invention is related to a method and system for providing a wireless transmit/receive unit (WTRU) status, in providing real time services via a wireless local area network interworking with 3GPP systems. An entity such as a packet data gateway (PDG) in the 3GPP network stores and maintains the current state of the WTRU and updates the state of the WTRU when it changes. The WTRU signals a change in its state to the PDG. When the PDG receives a message from the 3GPP system directed to the WTRU, the PDG examines the status of the WTRU prior to forwarding the message to the WTRU.

### CROSS REFERENCE TO RELATED APPLICATION

This application claims the benefit of U.S. provisional application No. 60/576,753 filed Jun. 2, 2004, which is incorporated by reference as if fully set forth.

### FIELD OF INVENTION

The present invention is related to wireless local area networks interworking with 3GPP systems. More particularly, the present invention is related to a method and system for improving the reliability of real time services initiated by an entity in a 3GPP network to an entity in a wireless local area network (WLAN) interworking with the 3GPP system.

### BACKGROUND

Wireless local area networks (WLANs) and other wireless communication systems have become popular because of their convenience and flexibility. As the deployment and use of these systems increases, much work is being done to establish standards by which various systems can interwork. One new wireless communication system being standardized is called the Third Generation Partnership Project (3GPP). In order for WLANs to interwork with 3GPP systems, (such systems also being known as I-WLANs), they must be able to operate under a plurality of different scenarios and support a variety of services.

Most of the prior art in interworking WLAN systems with 3GPP communication systems relates to enabling a wireless transmit/receive unit (WTRU) operating on a WLAN to access a 3GPP network to which the WTRU user is a subscriber. The connection is established through a WLAN access gateway (WAG), to a packet data gateway (PDG), both of which are part of the 3GPP network. Once the connection is established, the WTRU on the I-WLAN can access services on the 3GPP system, including packet switched (PS) services.

However, most of the work done has been to facilitate access by the WTRU of resources on the 3GPP system, without much consideration given to users on the 3GPP system who might want to access the WTRU. For example, Voice over Internet Protocol (VoIP) is one of the services that an I-WLAN WTRU can support, using session initiation protocol (SIP). Thus, a WTRU on an I-WLAN can establish a 3GPP connection and place a VoIP call to a device on the 3GPP system. However, a 3GPP device cannot easily place a call to the WTRU, even though connected to the 3GPP system. Current 3GPP specifications treat a WLAN as a black box, with little information being provided to the 3GPP system regarding the WTRU. The only available information is whether the WTRU has established the necessary tunnel to a packet data gateway (PDG) of a 3GPP network in order to receive a particular service.

The PDG does not have access to any other information regarding the status of the WTRU; such as whether it is ON, whether it is in a SLEEP mode, or whether it is OFF or disconnected from the I-WLAN. This has negative consequences for users on the 3GPP network trying to communicate with the WTRU.

For example, in the case of a terminated VoIP (SIP) call to the WTRU, a WTRU on the 3GPP system sends to the WTRU on the I-WLAN a SIP_INVITE message. The proxy call state control function (P-CSCF) on the 3GPP system forwards the SIP_INVITE message to the PDG for routing to the WTRU operating on the I-WLAN. If the WTRU is in a SLEEP state, the message will be delayed at the access point (AP) of the I-WLAN, to be delivered when the WTRU wakes up. If the delay in delivering the SIP_INVITE message is long enough, without any progress report from the P-CSCF back to the sender, the WTRU will be perceived as “NOT RESPONDING/NOT AVAILABLE” by the sender and the call will be dropped.

Therefore, there is a need for providing information regarding the status of a WTRU to a PDG or any entity on a 3GPP network that is responsible for routing packet data to the WTRU.

### SUMMARY

The present invention is related to a method and system for providing a wireless transmit/receive unit (WTRU) status, in providing real time services via a wireless local area network interworking with 3GPP systems. The WTRU signals each change in its state to a packet data gateway (PDG) or other device in the 3GPP network. The PDG stores and maintains the current state of the WTRU and updates the state of the WTRU when it changes. When the PDG receives a message from a device on the 3GPP system directed to the WTRU, the PDG examines the state of the WTRU prior to forwarding the message to the WTRU. In the case that the WTRU is in an ASLEEP state, the message shall be stored and delivered when the WTRU wakes up. A paging mechanism may be used to inform the WTRU of a pending message.

### BRIEF DESCRIPTION OF THE DRAWINGS

The present invention will be understood from consideration of the drawings in which like elements are designated by like numerals, wherein:

FIG. 1 is a diagram of a WTRU traveling from an interworking wireless local area network (I-WLAN) access network (AN) associated with the WTRU's home 3GPP network, to a different I-WLAN AN associated with a different 3GPP network, called a visited network.

FIG. 2A is a diagram of a connection between a WTRU in an I-WLAN AN, and a call state control function (CSCF) which provides subscriber services in a 3GPP home network.

FIG. 2B is a diagram of a connection between a WTRU in an I-WLAN AN and a CSCF, wherein the state of the UE is maintained in a AAA server.

FIG. 3 is a diagram of the different states of the WTRU stored, and the actions prompting a change of the stored state.

FIG. 4 is a timing diagram of an attempted Voice over IP (VoIP) call from a CSCF in a 3GPP network to a WTRU in a I-WLAN, in which the WTRU is in an ASLEEP state and the call is dropped.

FIG. 5 is a timing diagram of a WTRU in an I-WLAN updating its state from ON to ASLEEP, after which a user in a 3GPP network attempts a VOIP call to the WTRU and is informed of the WTRU's state.

FIG. 6 is a timing diagram in which the WTRU wakes from the ASLEEP state and the PDG updates the WTRU state to WTRU_ON, after which the CSCF completes a VoIP call to the WTRU.

### DETAILED DESCRIPTION OF THE PREFERRED EMBODIMENTS

Hereinafter, a wireless transmit/receive unit (WTRU) includes but is not limited to a mobile station, fixed or mobile subscriber unit, pager, or any other type of device capable of operating in a wireless local area network (I-WLAN) interworking with a third generation partnership project (3GPP) network. Hereinafter, a user equipment (UE) includes but is not limited to a mobile station, fixed or mobile subscriber unit, pager, or any other type of device capable of operating in a 3GPP network interworking with an I-WLAN. Hereinafter, an access point (AP) includes but is not limited to a Node-B, site controller, base station or any other type of interfacing device in a WLAN environment.

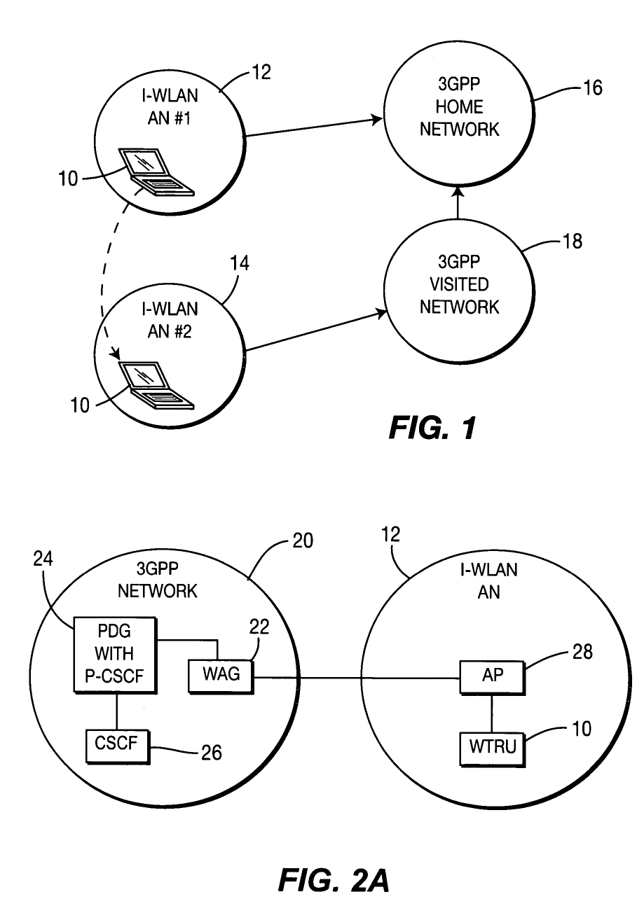

FIG. 1 shows a WTRU 10 traveling from an area served by a first I-WLAN AN (12) to an area served by a second I-WLAN AN (14). The WTRU (10) is able to access packet switched (PS) services from a 3GPP network via an I-WLAN AN. The user typically wants to ultimately connect to his own 3GPP home network (16) to which he is a subscriber. The first I-WLAN (12) is associated by a roaming agreement with the 3GPP home network (16), and the WTRU (10) can connect to the 3GPP home network (16) through the first I-WLAN (12). The second I-WLAN (14) is not associated with the user's 3GPP home network, but can provide 3GPP PS services from the user's home network through a 3GPP visited network (18). Authentication, authorization and accounting (AAA) are provided by an AAA server (not shown) via mechanisms well known to those skilled in the art.

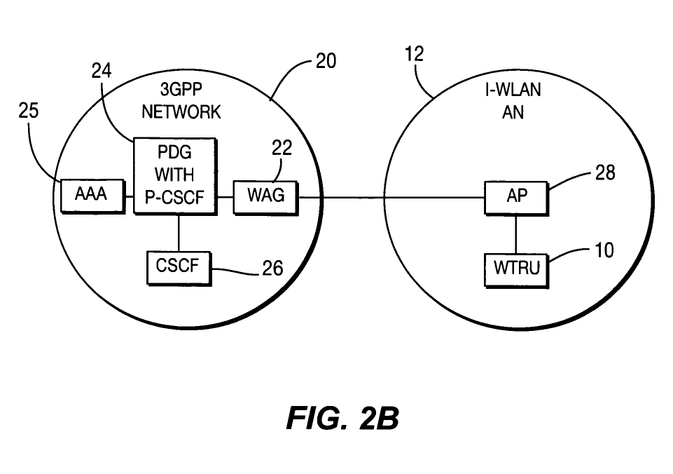

FIG. 2A shows a packet switched connection with a WTRU 10, through an I-WLAN AN 12, through a 3GPP network 20 to a call state control function (CSCF) 26 located therein. The 3GPP network 20 can be a home network, or a combination of a home network and a visited network. A WLAN Access Gateway (WAG) 22, and a Packet Data Gateway (PDG) 24, including a proxy-call state control function (P-CSCF), are shown in the 3GPP network 20. An access point (AP) 28 is shown in the I-WLAN. The WTRU 10 establishes a connection to the 3GPP network 20 via the AP 28, the WAG 22 and the PDG 24. All packet data directed between the 3GPP network 20 and the WTRU 10 are transmitted via the PDG 24 and the WAG 22 in the 3GPP network 20 and the AP 28 in the I-WLAN 12.

The WAG 22 generates charging information and forwards it to the AAA server for accounting purposes, and enforces routing of packets through the PDG 24. The PDG 24 maintains and updates routing information for the WTRU 10, and routes the packet data directed to it after performing address translation and mapping. According to the present invention, the PDG 24 also stores and maintains the state of the WTRU 10, and updates the state of the WTRU 10 whenever it changes. Although in a first embodiment the state of the WTRU 10 is stored and maintained in the PDG 24, the state of the WTRU 10 could be stored and maintained at another location, such as in a AAA server 25, as shown in FIG. 2B in a second embodiment.

Communications regarding the state of the WTRU 10 are transmitted via signaling, such as by internet protocol (IP), between the WTRU 10 and the PDG 24. The AP 28 communicates with wireless devices, such as WTRU 10, via an air interface, and connects them to the wired network. There are many other functions performed by the WAG 22, the PDG 24 and the AP 28 that are well known to those skilled in the art but are not relevant to the present invention. Accordingly, those functions will not be described in detail hereinafter.

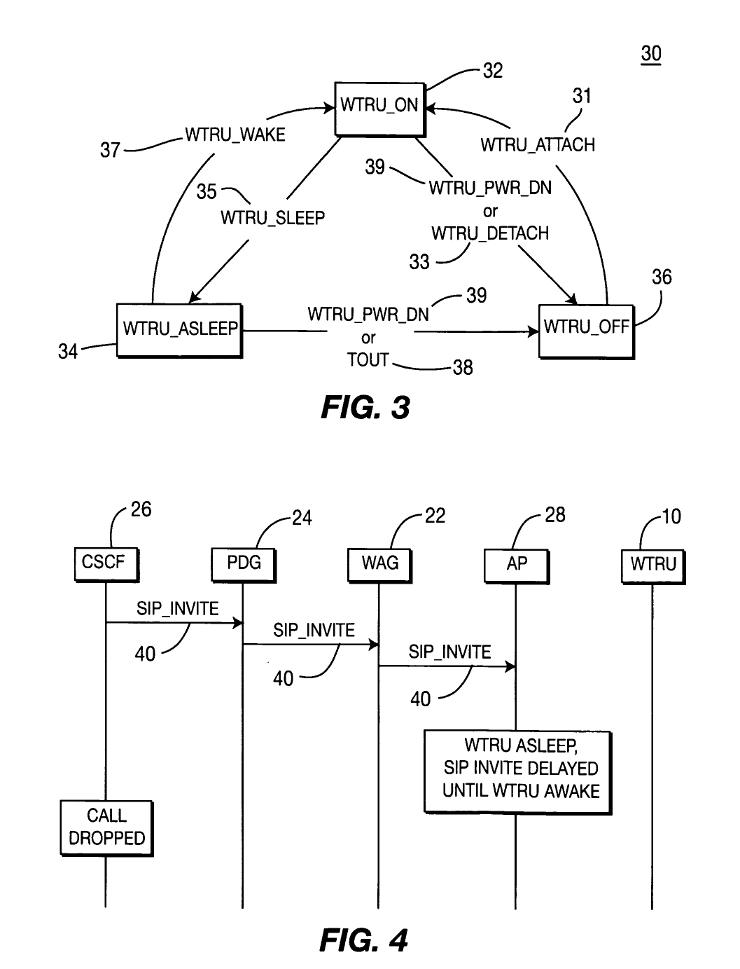

Referring to FIG. 3, a state diagram 30 of the state of the WTRU 10 as maintained at the PDG 24 in accordance with the present invention is shown. The state diagram 30 indicates three WTRU states which are defined as follows:

1. WTRU_ON (32)—The WTRU is powered on, is attached to an AP in the I-WLAN, and has established an IP tunnel with the PDG in a 3GPP network.

2. WTRU_ASLEEP (34)—The WTRU is powered on but has entered sleep mode. The tunnel with the I-WLAN is still ON.

3. WTRU_OFF (36)—The WTRU is currently powered off, or is detached from the AP, or the IP tunnel to the 3GPP PDG has simply been taken down.

It should be noted that although only three states are set forth in FIG. 3, the present invention is not limited to these three states. Those of skill in the art should realize that other states could be added in the future. It is only important that the state of WTRU 10 is stored and maintained in the 3GPP network.

The events internal relative to the WTRU 10 which trigger the sending of an update message in order to update of its state to the PDG 24 are also shown in FIG. 3 as:

1. WTRU_ATTACH (31)—The WTRU 10 is on and is connected to an AP 28, and has just set up an IP tunnel to the PDG 24 on the 3GPP network 20. The PDG 24 stores the state of the WTRU with an initial value of WTRU_ON (32).

2. WTRU_DETACH (33)—The WTRU 10 is about to disconnect from the AP 28, or is simply about to take down the IP tunnel to the PDG 24, for example, in response to a user command. The WTRU 10 sends a message indicating its imminent action to the PDG 24, and the state of the WTRU 10 stored at the PDG 24 is updated by the PDG 24 to WTRU_OFF 36.

3. WTRU_PWR_DN (39)—The WTRU 10 is about to power down, for example, in response to a user command. The WTRU sends a message indicating its imminent action to the PDG 24, and the state of the WTRU 10 stored at the PDG 24 is updated by the PDG 24 to WTRU_OFF 36.

4. WTRU_SLEEP (35)—The WTRU 10 is about to enter sleep mode, either in response to a user command or by timeout (i.e., the maximum permissible time without communication between the WTRU 10 and the AP 28 has been exceeded), but the WTRU 10 will still be associated with the IP tunnel to the PDG 24. The WTRU 10 sends a message indicating its imminent action to the PDG 24, and the state of the WTRt 10 stored at the PDG 24 is updated by the PDG to WTRU_ASLEEP 34.

5. WTRU_WAKE (37)—The WTRU 10 has just ended sleep mode and is actively communicating with an AP 28, and the IP tunnel to the PDG 24 is still active. The WTRU 10 sends a message indicating its action to the PDG 24, and the state of the WTRU 10 stored at the PDG 24 is updated by the PDG 24 to WTRU_ON 32.

One event which is not internal to the WTRU 10, but which is internal to the PDG 24, can also trigger an update of the state of the WTRU 10 at the PDG 24:

6. TOUT (38)—The maximum permissible time without communication from the WTRU 10 has been exceeded, as indicated by a timer in the PDG 24. The state of the WTRU 10 stored at the PDG 24 is updated by the PDG 24 to WTRU_OFF 36.

In the case of terminated traffic to a WTRU 10 from the 3GPP network 20 with which the PDG 24 is associated, the PDG 24 examines the state of the WTRU 10 prior to attempting to deliver the traffic to the WTRU 10. In the case that the WTRU 10 is in the WTRU_ASLEEP 34 state, the traffic is stored by the PDG 24 and delivered when the state of the WTRU 10 changes to WTRU_ON 32. The PDG 24 also sends a message 52 to the device that originated the traffic, indicating that the WTRU 10 is asleep. In a second embodiment, the PDG 24 can also use a paging mechanism to inform the WTRU 10 of pending traffic.

FIG. 4 illustrates a CSCF 26 on a 3GPP system 20 attempting to place a voice-over-IP (VoIP) call to a WTRU 10 on an I-WLAN AN, in which the WTRU 10 is in the WTRU_ASLEEP 34 state, without the benefit of the present invention. In this case, it is assumed that the WTRU 10 has an established tunnel to a PDG 24 on the 3GPP system and the WTRU 10 is in the WTRU_ASLEEP 34 state. The 3GPP network 20 is aware of the tunnel, but has no information regarding the state of the WTRU 10. The CSCF 26 sends a session initiation protocol (SIP) INVITE message 40 to the WTRU 10 via a Proxy Call State Control Function (P-CSCF) within the PDG 24. The P-CSCF within the PDG 24 forwards the SIP_INVITE message 40 to the PDG 24 for routing to the WTRU 10, and the PDG 24 forwards it to the WAG 22, and thence to the AP 28 in the I-WLAN AN 12 with which the WTRU 10 is associated. Since the WTRU 10 is in the WTRU_ASLEEP 34 state, the message will be stored at the AP 28 until the WTRU 10 wakes up. The delay in delivering the SIP_INVITE message 40, without any progress report from the P-CSCF back to the sender, will be interpreted as the WTRU “NOT RESPONDING/NOT AVAILABLE” by the sender, and the call will be dropped.

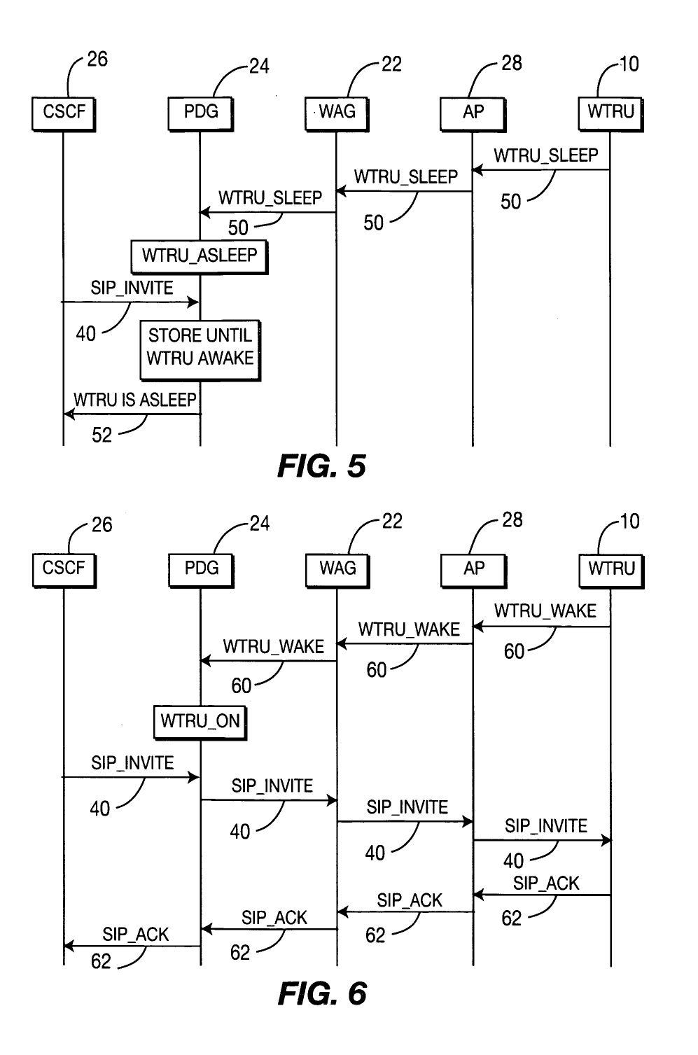

FIG. 5 illustrates a similar scenario in which a CSCF 26 on a 3GPP system 20 attempting to place a voice-over-IP (VoIP) call to a WTRU 10 on an I-WLAN AN 12, in which the WTRU 10 is in the WTRU_ASLEEP 34 state and in which the present invention is used. In this case, it is also assumed that the WTRU 10 has again established a tunnel to a PDG 24 on the 3GPP system 20 and the WTRU 10 is about to enter the WTRU_ASLEEP 34 state. The WTRU 10 sends a WTRU_SLEEP message 50 to the AP 28 which forwards the message 50 to PDG 24 via the WAG 22.

Upon receipt of the WTRU_SLEEP message 50, the PDG 24 changes the stored state of the WTRU 10 to WTRU_ASLEEP 34. The 3GPP network 20 is now aware of the tunnel, and also has information regarding the state of the WTRU 10. Accordingly, when the CSCF 26 sends an SIP_INVITE message 40 to the WTRU 10 via a P-CSCF in the PDG 24, the P-CSCF forwards the SIP_INVITE message 40 to the PDG 24 for routing to the WTRU 10, and the PDG 24 checks the state of the WTRU 10 before attempting to forward the SIP_INVITE message 40 to the WTRU 10. Since the state of the WTRU 10 stored at the PDG 24 is the WTRU_ASLEEP 34 state, the message is not forwarded. The PDG 24 sends a message 52 to the CSCF 26 indicating the WTRU 10 is in the WTRU_ASLEEP 34 state, and the SIP_INVITE message 40 is stored at the PDG 24 until the WTRU 10 wakes up. The CSCF 26 can decide whether to wait for the WTRU 10 to wake up, and if so, the call will not be dropped. The PDG 24 can use a paging-like mechanism to inform the WTRU 10 of a pending message.

FIG. 6 illustrates a CSCF 26 on a 3GPP system 20 placing a voice-over-IP (VoIP) call to a WTRU 10 on an I-WLAN AN 12 which was in the WTRU_ASLEEP 34 state and woke up, in which the present invention is used. In this case, the WTRU 10 has an active tunnel to the PDG 24 on the 3GPP system and is in the WTRU_ASLEEP 34 state. When the WTRU 10 wakes up, it sends to the PDG 24 a WTRU_WAKE message 60 via the AP 28 and the WAG 22. The PDG 24 receives the WTRU_WAKE message 60 and changes the stored state of the WTRU to the WTRU_ON 32 state. The 3GPP network 20 is now aware of the tunnel, and also has information regarding the WTRU_ON 32 state of the WTRU 10.

The CSCF 26 sends a SIP_INVITE message 40 to the WTRU 10 via a P-CSCF in the PDG 24. The P-CSCF forwards the SIP_INVITE message 40 to the PDG 24 for routing to the WTRU 10, and the PDG 24 checks the state of the WTRU 10 before attempting to forward the SIP_INVITE message 40 to the WTRU 10. Since the state of the WTRU 10 stored at the PDG is WTRU_ON 32 state, the SIP_INVITE message 40 is forwarded. The SIP_INVITE message 40 is passed through the WAG 22 and the AP 28 to the WTRU 10. The WTRU 10 responds by sending a SIP_ACK message 62 to the CSCF 26, which is forward through the AP 28, the WAG 22 and the PDG 24 to the CSCF 26, and the VoIP session is thereby established.

Although the features and elements of the present invention are described in the preferred embodiments in particular combinations using VoIP, 3GPP, PDG and AAA server, each feature or element can be used alone without the other features and elements of the preferred embodiments or in various combinations with or without other features and elements of the present invention, and using other communication services, standards and devices.

1. A method of indicating in a third generation partnership project (3GPP) system the current state of a wireless transmit/receive unit (WTRU) in communication with a wireless local area network (I-WLAN) interworking with the 3GPP system, the method comprising:
establishing a tunnel between the WTRU and a packet data gateway (PDG);
sending from the WTRU to the PDG a message indicating the WTRU's state; and
storing in the PDG the WTRU's state.

2. The method of claim 1 further comprising:
the WTRU changing to a different state and sending to the PDG a state change message indicating the change to a different state; and
the PDG receiving the state change message and storing the WTRU's different state.

3. The method of claim 2 wherein the state of the WTRU is one of ON, OFF and ASLEEP, and the PDG stores a corresponding state of WTRU_ON, WTRU_OFF or WTRU_ASLEEP, respectively.

4. The method of claim 3 wherein when the WTRU is turned on, the WTRU sends to the PDG a message indicating the WTRU's state is ON, and the PDG updates the state of the WTRU to WTRU_ON.

5. The method of claim 3 wherein the WTRU sends to the PDG a message indicating the WTRU will power down;
the PDG updates the state of the WTRU to WTRU_OFF; and
the WTRU changes its state to OFF.

6. The method of claim 3 wherein the WTRU sends to the PDG a message indicating the WTRU will change its state to ASLEEP;
the PDG updates the state of the WTRU to WTRU_ASLEEP; and
the WTRU changes its state to ASLEEP.

7. The method of claim 3 wherein the WTRU changes its state automatically after a period of time WTRU_TOUT during which no communication has been made with an I-WLAN access point (AP).

8. The method of claim 3 wherein when the WTRU receives a WAKE command, the WTRU sends to the PDG a message indicating the WTRU's state will change to ON;
the PDG updates the state of the WTRU to WTRU_ON; and
the WTRU changes its state to ON.

9. The method of claim 5 wherein the PDG automatically updates the state of the WTRU to WTRU_OFF after a preferred period of time PDG_TOUT during which no communication from the WTRU has been received by the PDG.

10. A method of initiating a communication session using a packet switched (PS) service from a call state control function (CSCF) in a third generation partnership project (3GPP) system to a wireless transmit/receive unit (WTRU) communicating with a wireless local area network (I-WLAN) interworking with the 3GPP system, the method comprising:
providing an entity within the 3GPP system which stores the current state of the WTRU;
sending a request from the CSCF to the entity for a connection with the WTRU;
checking the state of the WTRU by the entity; and
determining the disposition of the request based on the stored state of the WTRU.

11. The method of claim 10 wherein the state of the WTRU is one of ON, OFF and ASLEEP, and the entity stores a corresponding state of WTRU_ON, WTRU_OFF or WTRU_ASLEEP, respectively.

12. The method of claim 11 wherein when the WTRU is turned on, the WTRU sends to the entity a message indicating the WTRU's state is ON, and the entity updates the WTRU's state as WTRU_ON.

13. The method of claim 11 wherein when the checking step includes indicating the state of the WTRU is WTRU_ON, and the determining step includes forwarding the request to the WTRU.

14. The method of claim 11 wherein when the checking step includes indicating the state of the WTRU is WTRU_OFF, and the determining step includes not forwarding the request to the WTRU.

15. The method of claim 11 wherein when the checking step includes indicating the state of the WTRU is WTRU_ASLEEP, and the determining step includes storing the request and sending a message to the CSCF indicating the WTRU is ASLEEP.

16. The method of claim 15 wherein when the entity thereafter receives from the WTRU a message indicating the WTRU's state is changing to ON, the entity updates the state of the WTRU to WTRU_ON, and forwards the stored request to the WTRU.

17. The method of claim 15 wherein the entity uses a paging mechanism to inform the WTRU of a pending message.

18. A packet data gateway (PDG) for use in a third generation partnership project (3GPP) system which maintains the current state of a wireless transmit/receive unit (WTRU) communicating with a wireless local area network (I-WLAN) interworking with the 3GPP system, the PDG comprising:
means for establishing an IP tunnel with the WTRU;
means for receiving from the WTRU a message indicating the WTRU's state;
means for storing the WTRU's state.

19. The PDG of claim 18 wherein the message indicates the state of the WTRU is one of ON, OFF and ASLEEP, and the PDG stores the received state.

20. The PDG of claim 19, further comprising means for tracking the elapsed time since the last communication from the WTRU, whereby the PDG automatically changes the stored state to indicate the WTRU as OFF after a preferred period of time during which no communication from the WTRU has been received by the PDG.

21. A system for establishing and maintaining a communication session between a call state control function (CSCF) in a third generation partnership project (3GPP) network and a wireless transmit/receive unit (WTRU) communicating with a wireless local area network (I-WLAN) interworking with the 3GPP network, the system comprising:
the WTRU comprising:
means for establishing an IP tunnel to the 3GPP network; and
means for reporting its state to the 3GPP network;
the CSCF operatively associated with a packet data gateway (PDG), for sending a request to the PDG for a connection with the WTRU; and
the PDG comprising:
means for establishing an IP tunnel with the WTRU;
means for storing the state of the WTRU;
means for receiving said request;
means for checking the stored state of the WTRU.
means for determining the disposition of the request based on the stored state of the WTRU.

22. The system of claim 21 wherein the state of the WTRU is one of ON, OFF and ASLEEP, and the PDG stores the corresponding state.

23. The system of claim 22 wherein the PDG forwards the request if the stored state of the WTRU indicates the WTRU is ON.

24. The system of claim 22 wherein the PDG does not forward the request if the stored state of the WTRU indicates the WTRU is OFF.

25. The system of claim 22 wherein the PDG stores the request if the stored state of the WTRU indicates the WTRU is ASLEEP, and the PDG sends a message to the CSCF indicating the WTRU is ASLEEP.

26. The system of claim 25 wherein the PDG forwards the request if the state of the WTRU changes from ASLEEP to ON.

27. The system of claim 25 wherein the PDG further comprises paging means to inform the WTRU of a pending message.
